(19) United States
(12) Patent Application Publication
(10) Pub. No.: US 2002/0028369 A1
(43) Pub. Date: Mar. 7, 2002

(54) Fuel cell with modular flexible gas distribution structures

(76) Inventor: Frank Thom, Julich (DE)

Correspondence Address: KLAUS J. BACH & ASSOCIATES, PATENTS AND TRADEMARKS, 4407 TWIN OAKS DRIVE, MURRYSVILLE, PA, 15668, US

(21) Appl. No.: 09/945,490

(22) Filed: Sep. 1, 2001

Related U.S. Application Data
(63) Continuation-in-part of application No. PCT/EP00/01700, filed on Feb. 29, 2000.

(30) Foreign Application Priority Data
Mar. 3, 1999 (DE) 199 08 989.2

(51) Int. Cl. H01M 8/02

(52) U.S. Cl. 429/34; 429/38; 429/39

(57) ABSTRACT

In a fuel cell including two electrodes, an electrolyte layer disposed between the two electrodes and a gas distribution structure for supplying an operating medium to an electrode, the gas distribution structure consists of several modular gas distribution units, which are interconnected with one another in a flexible manner.

This is a Continuation-In-Part of international application PCT/EP00/01700 filed Feb. 29, 2000 and claiming the priority of German application 199 08 989.2 filed Mar. 03, 1999.

### BACKGROUND OF THE INVENTION

The invention related to a fuel cell with a gas distribution structure.

A fuel cell includes a cathode, an electrolyte as well as an anode. Fuel such as hydrogen is admitted to the anode and an oxidation medium such as air is supplied to the cathode.

There are different types of fuel cells known in the art such as the SOFC fuel cell which is disclosed in DE 44 30 958 C1 as well as the PEM fuel cell disclosed in DE 195 31 852 C1.

The SOFC fuel cell is also called high-temperature fuel cell since its operating temperature is 700 to 1000° C. At the cathode of a high temperature fuel cell, oxygen ions are formed in the presence of the oxidation medium. The oxygen ions pass through the electrolyte and recombine at the anode side with the hydrogen of the fuel to form water. With the recombination electrons are released whereby electric energy is generated.

The operating temperature of a PEM fuel cell is about 80° C. At the anode of a PEM fuel cell protons are formed in the presence of the fuel by means of a catalyst. The protons pass through the electrolyte and combine at the cathode side with the oxygen provided by the oxidation medium to form water. In the process, electrons are released and electric energy is generated.

For increased electrical power generation, several fuel cells are generally electrically and mechanically interconnected by connecting elements. An example for such a connecting element is the bipolar plate disclosed in DE 44 10 711 C1. With such bipolar plates, fuel cells can be stacked on top of one another to form serially arranged fuel cells.

Bipolar plates or gas distributors known so far have the following disadvantages:

the gas passages which are mechanically formed into the gas distributors are the cause of a relatively large material consumption. The material cut out to form the passages is lost. Furthermore, the cutting procedure is relatively expensive.

Gas distributors already manufactured cannot be used in combination to provide larger area gas distributors. Rather new correspondingly larger gas distributors must be manufactured.

Areas of the gas distributor which have been locally worn as a result of the operation (for example, by corrosion, mechanical wear) cannot be separated from areas which are still operational. Expensive maintenance work or replacement of the whole gas distributor may be necessary.

The connecting elements include distribution structures for the operating media. With a distribution structure, an operating medium is suitable distributed over an electrode.

As fuel, methane or methanol may be provided among others. The fuels mentioned are converted to hydrogen or hydrogen-rich gas by reformation or oxidation.

It is known from DE 195 198 47 C1 to reform a fuel internally, that is, directly at the anode of a PEM fuel cells. DE 196 46 354 discloses that a fuel such as methanol can be oxidized at the anode of a PEM fuel cell by means of a catalyst such as platinum whereby hydrogen is released.

In a fuel cell, there are temperature differences. They may be caused by air cooling (Ch. Rechenauer, E. Achenbach, “Dreimenionale mathematische Modellierung des stationären und instationären Verhaltens oxidcheramischer Hochtemperature Brennstoffzellen Jül-2752) (tree dimensional mathematical modelling of the stationary and instationary behavior of oxideceramic high-temperature fuel cells). On the other hand, temperature differences can be generated by the non-uniform distribution of the methane conversion speed (P. Vernoux, J. Guindet, M. Kleitz, “Gradual Internal Methane Reforming in Intermediate-Temperature Solid Oxide Fuel Cells, J. Electrochem. Soc. Vol. 145, No. 10, 1998, pp. 3487-3492), (J. Meusinger E. Riensche, U. Stimming, “Reforming of Natural Gas in Solid Oxide Fuel Cell Systems”, Journal of Power Sources 71 (1998), pp. 315-320). Because of the different expansion coefficients of the materials of which a fuel cell consists (FACTS & FIGURES, an International Energy Agency SOFC Task Report, Berne, APRIL 1992) different temperatures result in thermo-mechanical tensions which may lead to material failures. Furthermore, the cyclic operation (power up and powering down of a fuel cell stack, load changes) lead to a non-isothermal behavior (Ch. Rechenauer, E. Achenbach, Dreidimensionale mathematische Modellierung des stationären und instationären Verhaltens oxidcheramischer Hochentemperaturbremstoffsollen Jül-2752) (transl. see previous above).

Thermo-mechanical tensions can result in irreversible damages (for example, irreversible bending of the connecting structure, changes in length. This bending results in efficiency losses because of:

local tension peaks at the contact points electrode—gas distributor and, respectively, electrode—bipolar plate, which may lead to micro-cracks or which may lead to under-critical crack growth. This may result in leakages between the anodes—and the cathode space and/or in material failure.

a reduction in the contact locations between a bi-polar plate and the fuel cell and, consequently, in a non-uniform current density distribution.

It is the object of the invention to provide a fuel cell wherein damages as a result of thermal tensions are avoided and which is easy to manufacture.

### SUMMARY OF THE INVENTION

In a fuel cell including two electrodes, an electrolyte layer disposed between the two electrodes and a gas distribution structure for supplying an operating medium to an electrode, the gas distribution structure consists of several modular gas distribution units, which are interconnected with one another in a flexible manner.

The gas distribution structure include channels for guiding the operating medium. The channels are formed by a combination of several components, (modular gas distribution units), which are loosely in contact with one another. In other words, the components are not rigidly interconnected. The various components may be interconnected by flexible connecting means, for example one or several flexible foils or strips. The flexible connecting means such as foils or strips may be connected to the individual components, for example, by welding. A foil, which separates a cathode space (the space, in which the cathode is disposed or which is adjacent the anode) in a gas-tight manner, can be disposed loosely on the components forming the channels.

With the flexible building arrangement, thermally induced length changes can be compensated. Accordingly, the development of thermal tensions is avoided. The arrangement according to the invention has a stable behavior.

A modular gas distribution unit may be tubular. It includes openings, which extend to the adjacent electrode. An operating medium is directed to the electrode through such the openings. A gas distribution unit further comprises an inlet and an outlet by way of which an operating medium enters or leaves the modular gas distribution unit (depleted).

The arrangement according to the invention is particularly suitable for high temperature fuel cells since the thermally induced tensions are particularly problematic for this type of fuel cells.

### BRIEF DESCRIPTION OF THE DRAWINGS

FIG. 1 shows a modular gas distribution unit,

FIG. 2 shows a number of interconnected gas distribution units,

FIG. 3 shows the arrangement of the gas distributor between the anode and the cathode space,

FIG. 4 shows an interconnection by hooks, and

FIG. 5 shows hooks, which are interconnected for hook and eye interconnection.

### DESCRIPTION OF A PREFERRED EMBODIMENT

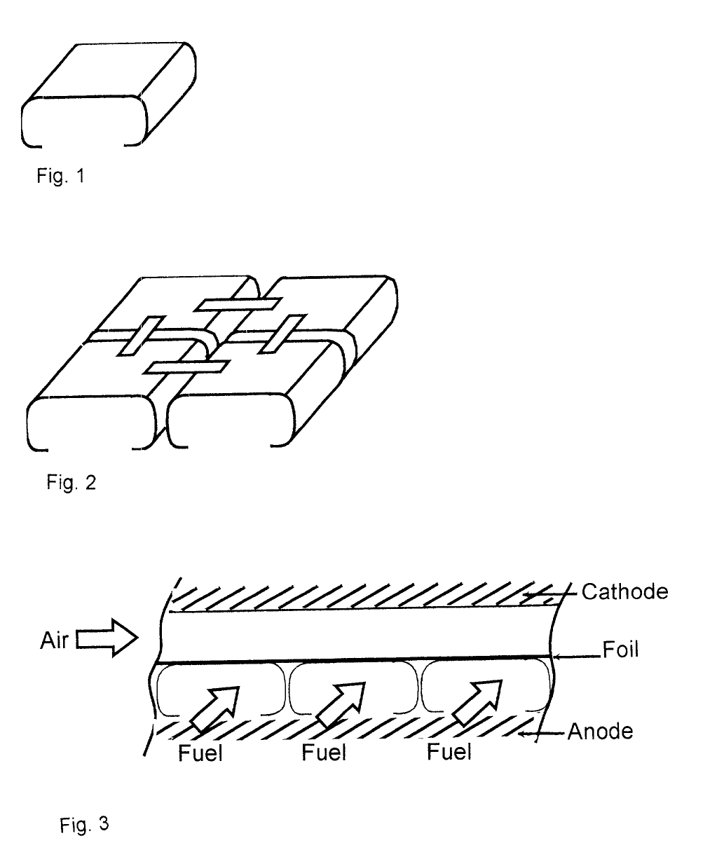

Individual modular gas distribution units (FIG. 1) can be made directly in a simple and inexpensive manner by cold-forming of metal sheets. If the modular gas distribution units are interconnected (for example, by welding of thin metal strips as shown in FIG. 2) gas distributors with any desirable area can be formed. Because of the flexibility of the connecting means, it is made sure that the gas distribution structure as a whole can be adapted to a desirable form (for example, a tubular form or a planar area).

FIG. 3 shows how the gas distributor is fitted between the anode—electrolyte—bipolar plate to make the separate supply of gases to the anode space and the cathode space possible. A cross-flow scheme is shown in the figure (the operating media for the anode and cathode sides flow crosswise).

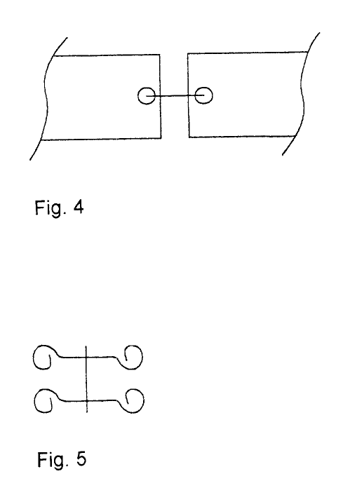

The electrical conductivity and gas-tightness between anode and cathode space may be ensured for example, by a metallic seal foil. This is achieved by the modular design of the gas distribution structure and a releasable interconnection between the individual modular units. Individual modular gas distribution units can, according to an advantageous embodiment of the invention, easily be interconnected by the hook and eye principle as shown—FIG. 4. The eyes are, for example, formed into the side walls of the gas distributor. The hooks interconnect the modular gas distributors. Three hooks can be interconnected as shown in FIG. 5 (the third hook is represented in FIG. 5 as a vertical line). Gas distributors of any desirable area can be built in this manner.

What is claimed is:

1. A fuel cell including two electrodes (anode, cathode), an electrolyte layer disposed between the two electrodes and a gas distribution structure for distributing an operating medium over an electrode, said gas distribution structure consisting of several modular gas distribution units which are interconnected with one another in a flexible manner.

2. A fuel cell according to claim 1, wherein said modular gas distribution unit has the shape of a tubular structure provided with at least one opening leading to an adjacent electrode.

3. A fuel cell according to claim 1, wherein a foil is disposed adjacent the modular gas distribution unit, which foil separates the anode from the cathode in a sealing fashion.

4. A fuel cell according to claim 1, wherein said modular gas distribution unit consists of a bent metal sheet.

5. A fuel cell according to claim 1, wherein said fuel cell is a high-temperature fuel cell.
